(19) United States
(12) Patent Application Publication
(10) Pub. No.: US 2003/0016357 A1
(43) Pub. Date: Jan. 23, 2003

(54) Measurement of aerosol mass concentration and mass delivery rate

(76) Inventors: Frederick M. Shofner, Knoxville, TN (US); F. Michael Scofner, II, Knoxville, TN (US)

Correspondence Address: STEVEN C. SCHNEDLER, CARTER & SCHNEDLER, PA, 56 CENTRAL AVE., SUITE 101, PO BOX 2985, ASHEVILLE, NC, 28802, US

(21) Appl. No.: 10/182,560

(22) PCT Filed: Feb. 22, 2001
(86) PCT No.: PCT/US01/05948

(51) Int. Cl. G01N 21/51

(52) U.S. Cl. 356/337

(57) ABSTRACT

Methods and systems employing multiple sensing volumes (50) for electro-optical mass concentration measurement and controlled deliveries of aerosols. Aerosols are transported in a gas flow stream (15). A sensor responsive to particles within a relatively larger sampling volume (156) within the gas flow stream is combined with another sensor responsive to particles within a relatively smaller sampling volume (162) within the gas flow stream.

### TECHNICAL FIELD

The invention relates to electro-optically measuring the mass concentrations and controlling the mass deliveries of aerosolized powders transported in conduits by gas flows.

### BACKGROUND ART

Aerosol photometers are available which respond to low aerosol concentrations, typically in the range of 20 to 200 mg/m³, as with the Handheld Aerosol Monitor, HAM, manufactured by ppm, Inc, Knoxville, Tenn., USA. Such photometers are not available for the 5 to 50 fold higher concentrations required for certain pharmaceutical manufacturing applications. In conceivable principle, however, such electro-optical devices could be constructed, as either light scattering mode or light extinction mode sensors, and could have certain advantages of simplicity and large sampling volumes. Unfortunately, the readings of such devices would be fundamentally and heavily dependent upon the characteristics of the aerosols being measured, notably particle size distribution. It follows that photometer readings alone are not and cannot be generally useful for mass concentration measurements as applied to production processes. Further, photometer readings cannot provide any information about particle size distribution.

Single particle counters are available which respond to particle size distributions of low concentration aerosols but not at the high concentrations mentioned above. Mass concentration information is not available. Further, the sampling volumes of such counters is notoriously small. Still further, such known counters cannot be reliably integrated into industrial manufacturing processes. It follows that such counters cannot be extended to measuring particle size distributions in industrial process conduits at high mass concentrations, especially when the aerosols transported are highly variable across the transport cross section.

### DISCLOSURE OF THE INVENTION

It is therefore seen to be desirable to overcome the deficiencies of prior art electro-optical sensors when applied to contemporaneous measurements of both mass concentration and particle size distributions for high concentration, small size aerosols transported in industrial process conduits. It is also seen to be desirable to enable heretofore unknown measurements of mass delivery rates.

Embodiments of the invention enable the accurate and precise measurement of the mass concentrations of relatively fine (mean diameter approximately one to ten microns) aerosolized powders at relatively high concentrations (approximately 1 to 10 grams/m³ (mg/L), or higher). Further, as a practical matter, embodiments of the invention enable such measurements in view of real world variabilities in mean particle size, concentration and nonuniformities across the transport cross section within transport conduits.

In one embodiment, a method is provided for measuring mass concentration of aerosols being transported in a gas flow stream. The method includes employing a first sensor responsive to particles within a relatively larger sampling volume within the gas flow stream to develop an uncompensated output signal representative of mass concentration but uncompensated for particle size distribution. The relatively larger sampling volume has the capacity to contain a plurality of particles. The method also includes employing a second sensor responsive to particles within a relatively smaller sampling volume within the gas flow stream to develop a compensating signal representative of particle size distribution, the relatively smaller sampling volume being sized so as to contain only one particle larger than a predetermined minimum size. The method further includes the step of determining mass concentration by applying the compensating signal to compensate the uncompensated output signal for particle size distribution.

In another embodiment, a corresponding system is provided for measuring mass concentration of aerosols being transported in a gas flow stream. The system comprises a first sensor responsive to particles within a relatively larger sampling volume within the gas flow stream to develop an uncompensated output signal representative of mass concentration but uncompensated for particle size distribution. The relatively larger sampling volume has the capacity to contain a plurality of particles. The system additionally includes a second sensor responsive to particles within a relatively smaller sampling volume within the gas flow stream to develop a compensating signal representative of particle size distribution. The relatively smaller sampling volume is sized so as to contain only one particle larger than a predetermined minimum size. The system additionally includes an analysis device operable to determine mass concentration by applying the compensating signal to compensate the uncompensated output signal for particle size distribution.

In another embodiment, a method is provided for measuring mass concentration and particle size distribution of aerosols transported in a conduit, based on light scattering from multiple scattering volumes. The method includes the step of transporting aerosols to a measurement position in the conduit. The method further includes the step of employing illumination, optical collectors and detectors to define a plurality of sampling volumes at the measurement position, such that the scattered light response for each of the sampling volumes is maximal inside and minimal outside the particular volume, and with the largest sampling volume being generally concentric with and enclosing the smallest sampling volume, and with the smallest sampling volume size based on the expected range of mass concentrations and particle size distributions to be measured. The sampling volume sizing determination is to choose the smallest volume so that individual responses are produced for minimum particle diameters in the lower end of the relatively larger particle diameter range expected. The method additionally includes the steps of producing light scattering signal responses in proportion to collected scattered light from individual relatively larger particles within the sampling volumes, and producing light scattering signal responses in proportion to collective scattered light from a plurality of relatively smaller particles within the sampling volumes. The method further includes the steps of analyzing the signal responses from each of the multiple and generally concentric sampling volumes and determining by ratio and time coincidence criteria whether the individual responses from the multiple sampling volumes are valid, and processing the valid individual particle signals to produce mass concentration contribution and particle size distribution measurements for those particles larger than the minimum diameter; analyzing the signal responses from each of the multiple and generally concentric sampling volumes and determining the mass concentration contributions from the plurality of relatively smaller particles below the minimum diameter; combining the relatively larger particle and relatively smaller particle contributions; and computing and presenting measurement results of total mass concentrations in particle size distributions in relation to calibration results on similar aerosols.

In another embodiment there is provided a corresponding system for measuring mass concentration and particle size distribution of transported aerosols based on light scattering from multiple scattering volumes. The system includes a conduit within which aerosols are transported to a measurement position. The system additionally includes illumination, optical collectors and detectors defining a plurality of sampling volumes at the measurement position, such that the scattered light response for each of the sampling volumes is maximal inside and minimal outside the particular volume, and with the largest sampling volume being generally concentric with and enclosing the smallest sampling volume, and with the sampling volume size based on the expected range of mass concentrations and particle size distributions to be measured. The sampling volume sizing determination is to choose the smallest volume so that individual responses are produced for minimum diameter particles in the lower end of the relatively larger particle diameter range expected. The detectors produce light scattering signal responses in proportion to collected scattered light from individual, relatively larger particles within the sampling volumes, and the detectors produce light scattering signal responses in proportion to collected scattered light from a plurality of relatively smaller particles within the sampling volumes. The system additionally includes an analysis system operable to analyze the signal responses from each of the multiple and generally concentric sampling volumes and determine by ratio and time coincidence criteria whether the individual responses from the multiple scattering volumes are valid, and to process the individual particle signals to produce mass concentration contribution and particle size distribution measurements for those particles larger than the minimum diameter; analyze the signal responses from each of the multiple and generally concentric sampling volumes and determine the mass concentration contributions from the plurality of relatively smaller particles below the minimum diameter; combine the relatively larger particle and the relatively smaller particle contributions; and compute and present measurement results of total mass concentrations and particle size distributions in relation to calibration results on similar aerosols.

In another embodiment, a method is provided for measuring mass delivery rate of aerosols being transported in a gas flow stream. The method includes the steps of measuring volumetric flow rate within the gas flow stream, measuring mass concentration, and multiplying the measured volumetric flow rate by the determined mass concentration to determine mass delivery rate.

In one more particular embodiment of a method for measuring mass delivery rate, the step of measuring mass concentration includes employing a first sensor responsive to particles within a relatively larger sampling volume within the gas flow stream to develop an uncompensated output signal representative of mass concentration but uncompensated for particle size distribution. The relatively larger sampling volume has the capacity to contain a plurality of particles. The step of measuring mass concentration further includes employing a second sensor responsive to particles within a relatively smaller sampling volume within the gas flow stream to develop a compensating signal representative of particle size distribution. The relatively smaller sampling volume is sized so as to contain only one particle larger than a predetermined minimum size at a time. The step of measuring mass concentration further includes determining mass concentration by applying the compensating signal to compensate the uncompensated output signal for particle size distribution.

In another more particular embodiment or method for measuring mass delivery rate, the step of measuring mass concentration includes employing a sensor responsive to a plurality of small particles and to individual, relatively larger particles within a sampling volume within the gas flow stream to develop compensated signals representative of particle size distribution and total aerosol concentration.

In another embodiment, a corresponding system for measuring mass delivery rate of aerosols being transported in a gas flow stream is provided. The system includes a flow rate sensor for measuring volumetric flow rate within the gas flow stream, a mass concentration measurement system, and a device for multiplying the measured volumetric flow rate by the determined mass concentration to determine mass delivery rate.

In one more particular embodiment of a system for measuring mass delivery rate, the mass concentration measurement system includes a first sensor responsive to particles within a relatively larger sampling volume within the gas flow stream to develop an uncompensated output signal representative of mass concentration but uncompensated for particle size distribution. The relatively larger sampling volume has the capacity to contain a plurality of particles. The mass concentration measurement system additionally includes a second sensor responsive to particles within a relatively smaller sampling volume within the gas flow stream to develop a compensating signal representative of particle size distribution. The relatively smaller sampling volume is sized so as to contain only one particle larger than a predetermined minimum size at a time. The mass concentration measurement system additionally includes an analysis device operable to determine mass concentration by applying the compensating signal to compensate the uncompensated output signal for particle size distribution.

In another more particular embodiment of a system for measuring mass delivery rate, the mass concentration measurement system includes a sensor responsive to a plurality of small particles and to individual, relatively larger particles within a sampling volume within the gas flow stream to develop compensated signals representative of particle size distribution and total aerosol concentration.

### BRIEF DESCRIPTION OF THE DRAWINGS

FIG. 1 is a schematic representation, generally corresponding to a top plan view but partly sectioned, of an electro-optical mass concentration and mass delivery rate particle measurement embodiment of the invention;

FIG. 2 is a side elevational view, taken on line 1-1 of FIG. 1;

FIG. 3 is an enlargement of the sampling volume of the embodiment of FIGS. 1 and 2;

FIG. 4 is a plot depicting extinction mode detector response to particles of various sizes within a sampling volume;

FIG. 5 is a top view of another electro-optical measurement embodiment of the invention, employing two scattering-mode sensors;

FIG. 6 is an elevational view of the embodiment of FIG. 5;

FIG. 7 is a top view of another electro-optical measurement embodiment of the invention, employing scattering-mode and extinction mode sensors;

FIG. 8 is a side elevational view taken on line 8-8 of FIG. 7;

FIG. 9 is an end view taken generally on line 9-9 of FIG. 7, detailing generally concentric but unequal light scattering volumes;

FIG. 10 is an enlarged view to better show overlapping sensing volumes;

FIG. 11 shows plots of detector responses for particles moving on an trajectory through a point near the center of the small ellipsoid volume of FIG. 10;

FIG. 12 shows plots of detector responses for particles moving on a trajectory through a 1/e boundary point of the small ellipsoid volume of FIG. 10; and

FIG. 13 shows plots of detector responses for particles moving on a trajectory outside the large ellipsoid volume of FIG. 10.

### BEST MODE FOR CARRYING OUT THE INVENTION

In our developments of mass concentration sensors, as applied to controlled mass deliveries of aerosolized powders, we determined that the most general and basic case requires measurement of the number of aerosolized particles per second transported across differential elements of a cross sectional area of a conduit and the mass of each differential size class of such transported particles. Summation or integration of the normal component of this transport flux vector over the cross section yields aerosol mass flow rate in grams/second flowing in the conduit, normal to and across the cross section, for the differential classes of particle size. Summation or integration over all particle sizes yields total mass flow rate, dM/dt in grams/second. Summation or integration over time yields mass delivery M in grams in time T. Significantly, dM/dt so measured is dependent only on aerosol properties, including their spatial and vector velocity distributions, as well as on conduit size, but not on gas properties.

Surprisingly, we discovered that, in some special but practical industrial manufacturing cases, a “scalar” formulation and measurement permits sufficient precision and accuracy for practical application to mass concentration measurement and, thence, to controlled mass deliveries. We determined that such scalar formulation is valid when the aerosol sizes and speeds are small, when their vector directions are substantially parallel to the conduit, and when all particle sizes or classes are moving at nearly the same velocity as the mean transporting fluid velocity. We determined that this discovery is generally valid for aerosol sizes up to 20 μm, speeds up to 1 m/second, conduit internal diameters of order 1 cm, and transporting gases of air or nitrogen roughly near standard temperatures and pressures. We also determined other uniformity and steady flow conditions for which the generalities of a vector treatment may be relaxed.

In these special conditions, the “scalar” mass delivery rate measurement, dM/dt, in grams/second moving across a cross sectional plane of the conduit, is effected by independently and contemporaneously measuring the volumetric gas flow rate Q in m³/second, and aerosol mass concentration C in grams/m³, and forming the scalar product, dM/dt=QC.

When the basic assumptions are valid, embodiments disclosed in our International Application No. PCT/US00/08354 filed Mar. 30, 2000 titled “Controlled Deliveries and Depositions of Pharmaceutical and Other Aerosolized Masses,” and published Oct. 5, 2000 as No. WO 00/58016, can achieve practical and combined realization of accuracy and precision of mass flow deliveries of about 5% and can, in some cases, approach accuracy and precision in the order of 1%. There are no fundamental limits to dosage size or active/inert mass fractions. Dose deliveries that are as small as 1 microgram of active medication, with extension upward to milligrams and higher and downward to nanograms and lower are provided. These improved precision and accuracy results are achieved in spite of smaller and smaller ratios of active to inert components, versus order of magnitude 10% for prior art. Importantly, there are under evaluation powerful, expensive, new drugs, where the bioactive dose is only a few micrograms. When carried by an inert material whose mass is a few hundred milligrams, the mass ratio of active medication to inert carrier is evidently of the order of 1:100,000 or 0.001%.

Whereas the embodiments described in WO 00/58016 are practical and useful, provided certain clearly noted and basic assumptions are met, in some more demanding, critical, and “real-world” applications, aerosol transport nonuniformities and variabilities require more sophisticated apparatus and methods. These nonuniformities and variabilities include spatial nonuniformities of transport across the conduit cross section and non-constancy of particle size distribution (PSD). Improvements to accommodate such nonuniformities and variabilities are disclosed herein.

As employed herein, “aerosol” is a generic term which refers to finely divided liquid and dry powder materials, such as “atomized” sprays and “fluidized and dispersed” powders, respectively. To “aerosolize” a bulk liquid or powder generally means to break up the bulk material into small particles and to disperse them into a fluid medium, usually gaseous, for transport. Aerosolization is a key component of the aerosol generation and transport aspects of the embodiments disclosed in WO 00/58016.

The sizes of such finely divided particulate materials are in the range of less than about 1 μm, to several hundred μm in diameter. For reference purposes, respirable therapeutic aerosols are preferably of the order of a few μm, or smaller than about 10 μm, in order to reach the deep, alveolar recesses of the lungs. The therapeutic aerosol size range is between 10 μm and 100 μm for collection by or deposition within the bronchia. The size range is greater than 100 μm for nasal collection. “Respirable aerosols” are defined by the US Occupational Safety and Health Administration (OSHA) and Environmental Protection Agency (EPA) to be below about 10 μm; these governmental agencies indeed enforce laws which regulate the concentrations of so-called Particulate Matter-10 μm (PM 10 Standard) or corresponding definitions of aerosol size to which United States citizens and workers are exposed in the ambient environment and in the workplace, respectively. For oral injection or transdermal deliveries, aerosol size ranges are also typically 1-10 μm.

The following provides illustrative, practical design specifications: Aerosols are transported across a transport plane within a conduit by gas having a volumetric flow rate of Q in m³/second. According to the above assumptions, the aerosol mass delivery rate across the transport plane obeys, in the simple scalar but useful approximation:

\dot{M}=dM/dt=Q×C(grams/second) (1)

and the aerosol mass delivered or transported across the transport plane in time interval (0, T) is thus

$$M = {\int }_{o}^{T} QC ⅆ t . \qquad ( 2 )$$

In the general case, and most definitely in the case of those embodiments where aerosolization is pulsed in nature, thus leading to time-varying mass concentrations C and flow rates Q, the integral of Equation (2) is solved with appropriately small time increments to precisely and accurately control the mass delivered. For purposes of this explanation, it may be assumed that Q and C are steady, or constant in time, in which case the integral equation solution is trivial and the transported mass is simply

M=QCT(grams). (3)

As a numerical example, representative values of

Q=1 liter/min=16.7 ml/second=16.7×10⁻⁶ m³/second

C=1 gram/m³=1000 μg/liter, and

T=1 sec

yield

M=16.7 μg. (4)

That is, 16.7 μg of mass is delivered in each second across the transport plane when the average volumetric flow rate Q=1 liter/min and the Concentration C=1 gram/m³. These calculations reasonably illustrate the orders of magnitude for pharmaceutical manufacturing.

Different embodiments of the invention operate at very different values of QCT. Nanograms of mass delivery correspond to lower values of QCT, and tonnes of delivery correspond to higher values of QCT, but the principles are the same.

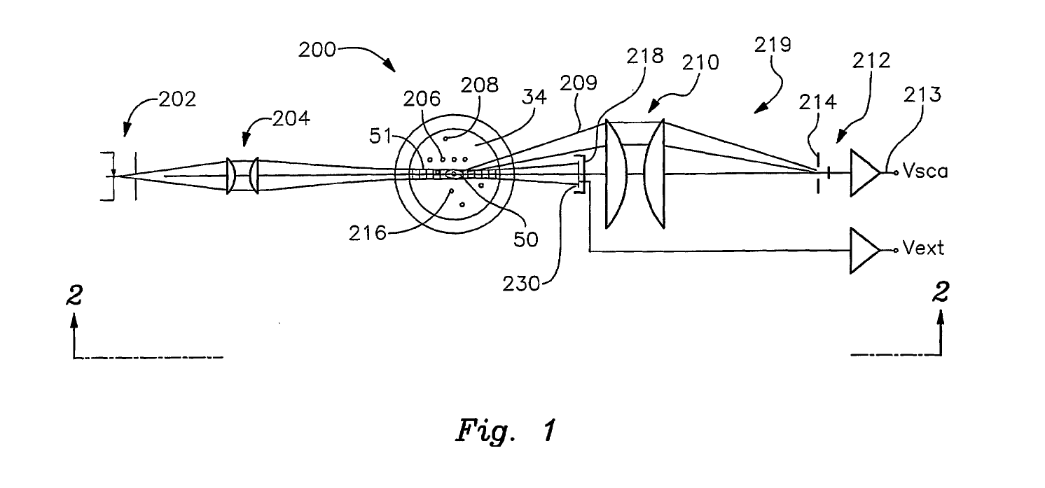

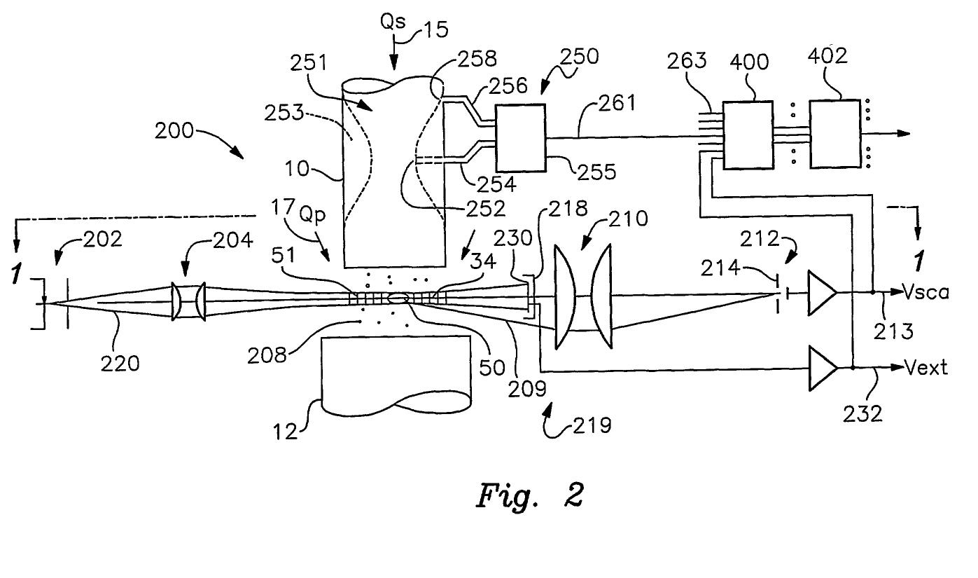

FIGS. 1 and 2 represent a basic electro-optical sensor 200 for mass concentration and particle size distribution measurements employing light scattering. The sensor 200 effects mass concentration and particle size distribution measurements of aerosol particles 208 transported through inlet and outlet conduits 10 and 12 in a gas flow stream Qₛ 15. Except for the extinction mode sensor elements consisting of detector 230 and signal processing electronics, symbolized by output Vₑₓₜ 232, near forward light scatter mode sensors constructed and operated according to such designs are standard products manufactured by ppm, Inc. of Knoxville, Tenn., USA. The addition of extinction mode sensor evolved from our discoveries and investigations into the measurement and control of mass deliveries, as disclosed herein. A series of standard ppm scatter mode sensors, known as “TX Sensors,” was originally developed for airborne concentration and particle size distribution (PSD) measurements in the field of human and animal exposures to toxic aerosols.

Provided the underlying assumptions described hereinabove are met, we have discovered that these scatter mode sensors, with their associated analog and digital electronics, in some cases perform in a manner that is quite satisfactory in embodiments described in WO 00/58016 with respect to the field of mass deliveries. The mass fraction capabilities of such sensors for measuring particle size distributions are especially noteworthy in this field. Mass fractions are a form of particle size distribution results wherein the cumulative fractions of mass larger than a given particle diameter are reported. Since this basic sensor design was a primary exploratory and investigative tool for our developments in the field of mass delivery applications, and is one of the primary building blocks for the improved system disclosed herein, described next is its operation for measuring mass concentration and size distribution via mass fractions, as well as its limitations for temporally unsteady, spatially nonuniform, high concentrations of small size aerosols. Following that description are disclosures of other embodiments offering improvements.

Accordingly, described next below with reference to FIGS. 1-3 is the operation of a single scatter mode sensor in the measurement of mass concentration and particle size distribution, as applied to mass delivery measurement and control.

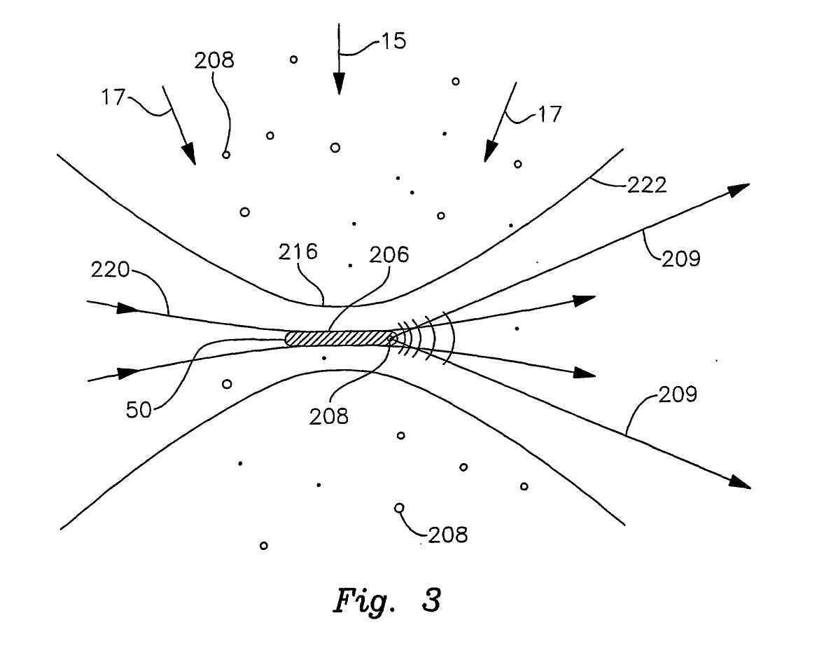

In FIGS. 1 and 2, a light source 202, such as a light emitting diode or a laser diode, directs a beam of light through beam-forming optics 204 to a beam focal volume 206 (as distinguished from a focal point). The beam focal volume 206 is defined by its minimum transverse width or waist 206, seen more clearly in the FIG. 3 enlargement. This optical configuration is known as a near forward light scattering system, or scatter mode sensor, and is used in embodiments of the invention to provide mass concentration C information about the aerosols transported in conduit 10, across transport plane 34, and as represented by the light scattering or sensing volume 50. The fraction of the transport plane 34 covered by the projection of the sensing volume 50 onto it is very small, approximately 1%, which, for purposes of embodiments of the invention, is atypical of other light scattering instruments. By projection of the sensing volume onto the transport plane we mean that maximum area of the scattering volume 50 projected onto the transport plane 34 in projection directions that are normal to the transport plane 34 or parallel to the local flow velocity vector associated with transport flow 15. Whereas in some applications this very small projected “proxy point” area, as a fraction of the total transport plane 34 area, is satisfactory, in other applications, especially for measuring mass deliveries, the small proxy point representation yields insufficient representation of the rest of the particle transport across transport plane 34, and solutions to this nonrepresentative sampling are enabled by embodiments of the invention disclosed herein.

According to the scalar computation for mass delivery rate dM/dt, both concentration C and volumetric flow rate Q are required. The volumetric flow rate sensor 250 seen in FIG. 2 operates within the transport conduit 10 and must be representative of the total flow Qₛ 15 which transports the aerosol across transport cross section 34. Volumetric gas flow rate Q sensor 250 is preferably physically near the transport plane 34. In the embodiment of FIG. 2 the volumetric gas flow sensors 250 is a venturi flow sensor operating as follows: sensor 255 senses differential pressure developed between throat tap 252 and wall tap 258 of venturi section 253, which taps are connected to differential pressure sensor 250 by tubes 254 and 256. This differential pressure reading is related to the volumetric flow rate Qs flowing into venturi inlet 251. Accordingly, C and Q are measured simultaneously and at the same thermodynamic and fluidynamic conditions. Whereas in some embodiments volumetric flow rate Q can be measured elsewhere in the system, the readings are always adjusted to correspond to provide actual volumetric flow at the thermodynamic and fluidynamic conditions at the location of the mass concentration C sensors.

Differential pressure sensors are manufactured by Sensym Inc, Milpitas, Calif., USA, and others. The venturi section 253 is manufactured by ppm, Inc, Knoxville, Tenn., USA, and others. Other volumetric flow sensing apparatus may also be used, such as available from Brooks Instruments, Hatfield, Pa., USA.

The above-described adjustments, computations, and communications of results and operation of the measurement and mass delivery system are handled by Control and Communications Module (CCM) 400, shown in FIG. 1. Volumetric flow sensor 250 output 261 and scatter mode sensor output 213, along with other inputs, are received by CCM 400, which may a microcontroller, such as HC 11 manufactured by Motorola. Output results of mass concentration, particle size distribution, or mass delivery rates are produced. (Extinction mode sensor output Vₑₓₜ 232 and its use are discussed below.) CCM 400 also controls the system via output ports 263. CCM has further I/O interfaces with one or more process computers 402.

Described next are dual mode, dual volume mass concentration measurements employing electro-optical sensors. For respirable aerosol measurements, or in certain pharmaceutical applications, the wavelengths are in the visible or near infrared range, from 400 to 1200 nanometers, with 800 to 1000 being typical, as provided with LEDs or diode lasers. Thus available electro-optical components such as illumination, optical elements, detectors, and the like are almost ideally suited for aerosols that are “micron-sized” or about 1000 nanometers in volume mean diameter.

Light scattered 209 from aerosol particles 208 within beam focal volume 206 is collected by collection optics 210 and focused or imaged onto an optical detector 212. The detector 212 is behind an aperture 214. The aperture 214 typically is a few tens to a few hundreds of micrometers in diameter. The size of the aperture 214 controls the optical collection volume 216 or waist 216. The detector 212 is typically slightly larger than the limiting aperture 214. In order to prevent direct illumination of the detector 212 by the incoming beam through the collection optics 210 there is a beam dump 218 in the form of a solid disc in front of the collection optics 210. The collection optics 210, optical detector 212, aperture 214 and beam dump 218 together comprise a collection optical system 219.

A sampling volume Vₛ 50 is defined by the intersection of the beam focal volume 206 and optical collection volume 216, near the waists for both. Significant scattered light 209 can only originate within the sampling volume Vₛ 50. Axial response is limited by the absence of particles 208, assured by purge air Qₚ 17, or by the axial response of the collection optical system 219. Sampling volume Vₛ 50 is shown as a cross-hatched area in FIG. 3 and is sometimes referred to as the “response ellipsoid.” The size of the sampling volume Vₛ 50 is a critical design parameter, as explained more fully below.

The scattered light 209 optical detector 212 does not actually respond to mass concentration C, the desired data product. Rather, the light scattering signals V_{sca} 213 output by the detector 212 have to be manipulated. For single particles near the center of the scattering volume Vₛ 50, and whose diameters d are larger than the wavelength of illumination, the response of the scattered light 109 optical detector 212 follows d². Accordingly, the detector 212 response “underweighs” particles relative to the ideal particle volume response d³, and large particle compensation is employed to make the response better approximate the ideal.

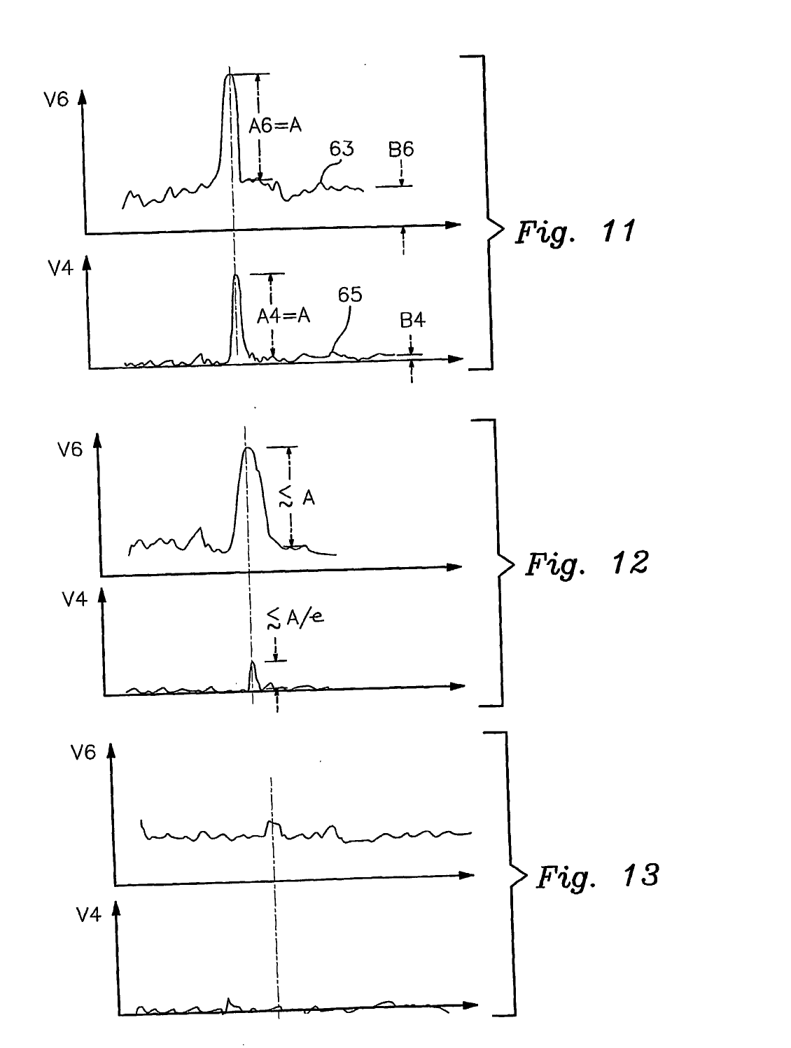

One such compensation 147 is to use the incremental scattering signal V_{sca} 213 raised to the 3/2 power, that is, A^{3/2}. (See FIG. 11.) As explained hereinbelow with reference to FIGS. 11-13, A is the maximum incremental voltage response, above a background B, for relatively large single particles passing through scattering volume Vₛ 50. The background is the collective response to a plurality of relatively small particles in the scattering volume Vₛ 50. If the particle concentration is low, such that single particles move though the sampling volume Vₛ 50, then distinguishable impulsive signals V_{sca} 213 are produced over and above the background. From such pulse height distributions the mass of each such single particle can be calculated using the A^{3/2} procedure, or other functional forms. If the particle concentration is high, such that more than one relatively small particle is within the sampling volume Vₛ 50 at one time, then single relatively large particles can still be detected above the small particle background. In either case, the particle size distribution, or what is equivalent, the mass fractions, for only the relatively large particles, may be calculated. No particle size distribution (PSD) information is available for multiple, relatively small particles in scattering volume Vₛ 50 because they do not yield distinguishable single pulses for the relatively small particles. However, their contributions to mass concentration are not ignored, as is explained below.

We explain more fully hereinbelow the relationship between particle diameter d and pulse height A and disclose how uniqueness in signal responses between A and d can be advantageously realized. The remainder of this discussion focuses on the scatter mode sensor elements of FIGS. 1 and 2, which do not necessarily have unique or “peaking” responses between d and A, but which nevertheless are useful for mass concentration and sizing measurements, especially as applied to the field of mass delivery.

Referring to the enlarged view of FIG. 3, the collection optical system 219 defines the optical collection volume 216 which is similar to the beam focal volume 206. That is, if a uniformly illuminated test particle 208 is moved around in the “field of view” of collection optical system 219, the scattered light 209 falling on the optical detector 212 (FIGS. 1 and 2) is largest at an axial distance corresponding to the waist of the optical collection volume 216 and decreases both transversely and axially. As with the beam focal volume 206, the converging-diverging lines represent contours of constant beam profile, such as the transverse 1/e points of intensity in beam 220 or 1/e points of response 222 of the collection optical system 219. Preferably, the optical collection volume 216 shares a common central point with the beam focal volume 206. Usually beam focal volume 206 is smaller than the optical collection volume 216, but this is not a requirement. Indeed, in some cases, particularly those with very high concentrations of small particles, a very thin “ribbon beam” is desirable.

The beam focal volume 206 defined by the beam forming optics 204 and the optical collection volume 216 defined by the collection optical system together, via their joint intersection, define the sampling volume Vₛ 50, as briefly described above, the size of which is very important, for the following reasons.

For low concentrations of large particles, the particle number concentration is low and the scattering signal V_{sca} 213 is large. The sampling volume Vₛ 50 can be so large, in the limit of very low concentrations, as with conventional single particle counters, that its projection 34 (in effect a cross section) onto the transporting gas flow stream Qₛ 15 is larger than the transporting conduits 10 and 12. But, for high mass concentrations of small particles, the particle number concentration is very high, behaving as C/d³ (where d is diameter and C is mass concentration), and the peak signals are smaller. The most serious practical problem for application to mass deliveries is that the projected area can be much less than 1% for the parameters discussed hereinabove. Thus the representativeness of such a small proxy area is seriously compromised when there are nonuniformities over the transport cross section 34.

What is needed is a sensor system which has the advantages of single particle mass concentrations, including particle size distribution data, plus a collective response from a large fraction of the transport cross section 34. This is achieved in the embodiments of the invention disclosed herein by the combination of a relatively smaller sampling volume Vₛ 50 sensor (disclosed herein as a scattering mode sensor) operating substantially contemporaneously with a relatively larger sampling volume Vₛ 50 sensor or an extinction mode sensor (disclosed herein as both scattering mode and extinction mode sensors). The operation of an extinction mode sensor having extinction mode volume Vₑ 51 will now be described.

Referring again to FIGS. 1 and 2, an extinction mode sensor is formed when another optical detector 230 is placed in front of beam dump 218. The extinction mode detector 230 is responsive to the extinction of light by the multiplicity of all aerosols in the beam, producing an extinction mode signal Vₑₓₜ 232. The extinction mode detector 230 can operate independently of and in parallel with scatter mode sensors 212 outputting light scattering signals V_{sca} 213. The extinction mode sensor volume Vₑ 51, jointly defined by the beam and the presence of particles, is shown in FIGS. 1 and 2 with vertical hatch lines.

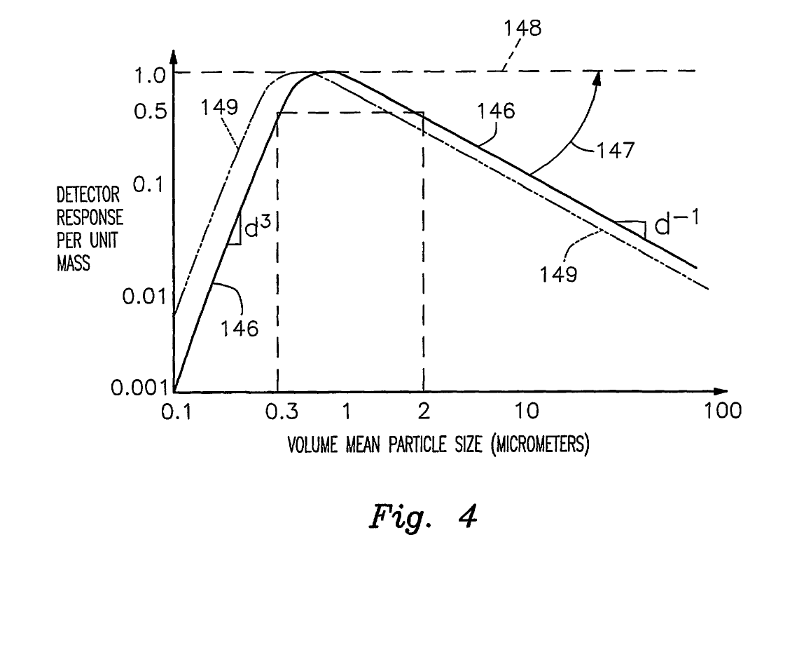

FIG. 4 is a plot 146 depicting extinction mode detector 230 response Vₑₓₜ 230 to particles of various sizes, ranging from a volume mean size of 0.1 microns to 100 microns, within a sampling volume Vₛ. Ideally mass concentration is accurately measured independently of particle size, which would correspond to a horizontal line 148 through unity on the ordinate. With an electro-optical extinction mode instrument and within the approximate range of 0.3 microns to 2 microns, the extinction response Vₑₓₜ 232 is within 50%. of ideal. Near particle size of 1 micron, response is nearly ideal. Maximum response occurs when mean particle size is approximately equal to the wavelength of the illuminating light. In this example, unity response corresponds to calibration with aerosols having volume mean diameter near maximum response. Of course, calibrations may be performed with aerosols having any known size distribution. For particle sizes smaller than 0.3 micron, the instrument is not as useful, as response per unit mass drops off as a function of d³.

It follows that, whereas the extinction mode sensor covers a larger percentage of the transport cross section 34, large particle compensation cannot be achieved because there are a multiplicity of particles in the beam, with the result that the extinction mode response depends on the volume mean particle size. It follows further that the poor cross sectional coverage weakness of scatter mode signals V_{sca} 213, compensates for the sensitivity to changes in particle size distribution weakness of the extinction mode signals Vₑₓₜ 232.

Accordingly, a significant feature of embodiments of the invention is the combination of a relatively small sampling volume sensor (typically a scattering mode sensor) with a relatively larger sampling volume sensor (which conveniently may be either an extinction mode sensor or a large Vₛ scattering mode sensor).

To achieve “large particle compensation” in the presence of relatively high concentrations, the sampling volume Vₛ can be made smaller. Alternatively, or in addition, the wavelength of the incident light beam can be made shorter, such as by employing a blue LED or a near ultraviolet laser. Such response is indicated by the plot 149.

As stated above, a problem with very small sampling volume Vₛ 50 is that relatively little of the particle transport or flow is measured. Thus, a relatively smaller portion of the cross section of the bore of the conduit 10 transporting the powder is sampled. Accordingly, the results are statistically less representative, and factors such as non-uniform transport velocities across the cross section can become a problem.

To properly implement “large particle compensation” the apparatus must be able to see and respond to relatively large particles within a cloud of smaller particles. For example, a single particle 10 microns in diameter can produce the same detector voltage output as 100 particles one micron in diameter within the same sample volume Vₛ. It follows that there is some minimum large particle diameter for which single particle pulses are usable.

In an embodiment of the invention, scattered light detection from two separate sampling volumes is implemented, one relatively larger and one relatively smaller. The relatively larger sampling volume, by way of example and not limitation, 0.5 mm³, is combined with the relatively smaller sampling volume, by way of example and not limitation, 0.005 mm³, sized so that single events occur whereby large particle compensation 147 (FIG. 4) can be achieved. For concentrations of 10 g/m³, d=1 μm, unit density, volumes of approximately 10⁻⁵ mm³ are appropriate. Volume shape can be used advantageously in design. Volumes much smaller than this can be achieved with good optical components and mounts.

Ideally, but not necessarily, the relatively smaller sampling volume is within the relatively larger sampling volume and generally concentric therewith. This can be achieved by having two light beams orthogonal to each other. Light of the same or different wavelengths can be employed within the two sampling volumes. In an alternative embodiment described hereinbelow using-an extinction mode sensor in place of the large scattering volume, illumination is preferably with a single ribbon beam.

Thus, in embodiments of the invention which use two volumes, a relatively large volume measurement sub-system that does not implement large particle compensation is combined with a relatively smaller volume instrument sub-system which does implement large particle compensation. The number of generally concentric, or overlapping, or “nested” volumes may be extended beyond two.

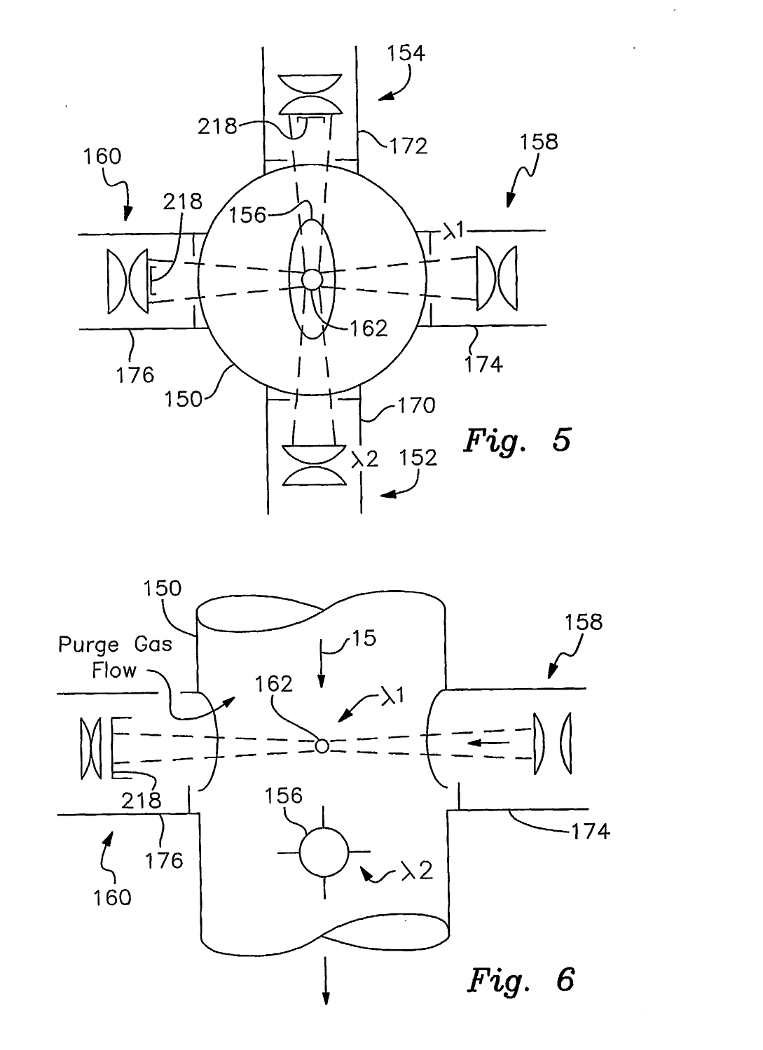

FIG. 5 is a top view and FIG. 6 is an elevational view of an embodiment of the invention using two scatter mode sensors. A conduit 150 transports aerosolized powder particles. Optical elements 152 and 154 define a relatively larger sampling volume Vₛ 156 within which a statistically significant quantity of particles are measured. Optical elements 158 and 160 define a relatively smaller sampling volume Vₛ 162 for which large particle compensation is implemented. The optical elements are contained within sealed mounting tubes 170, 172, 174 and 176. Although shown separated in FIG. 6, and with different illumination wavelengths λ₁ and λ₂, the two optical sub-systems and thus the two sampling volumes 156 and 162 can be co-planar. They can even be coaxial, as illustrated in FIGS. 1 and 2.

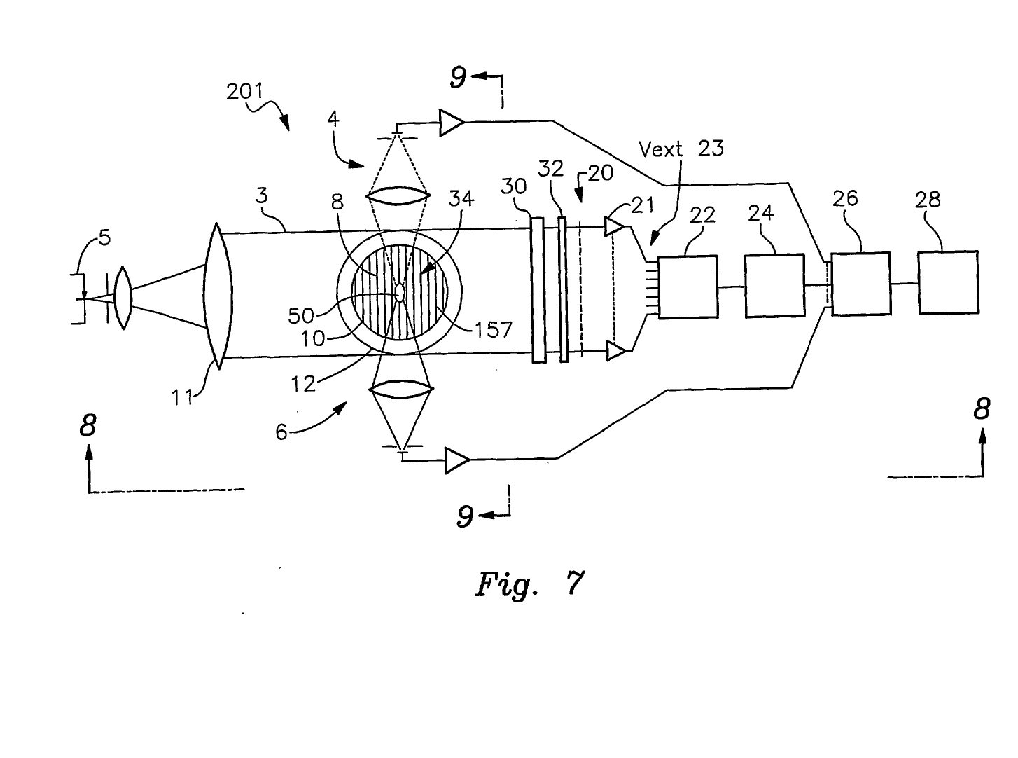

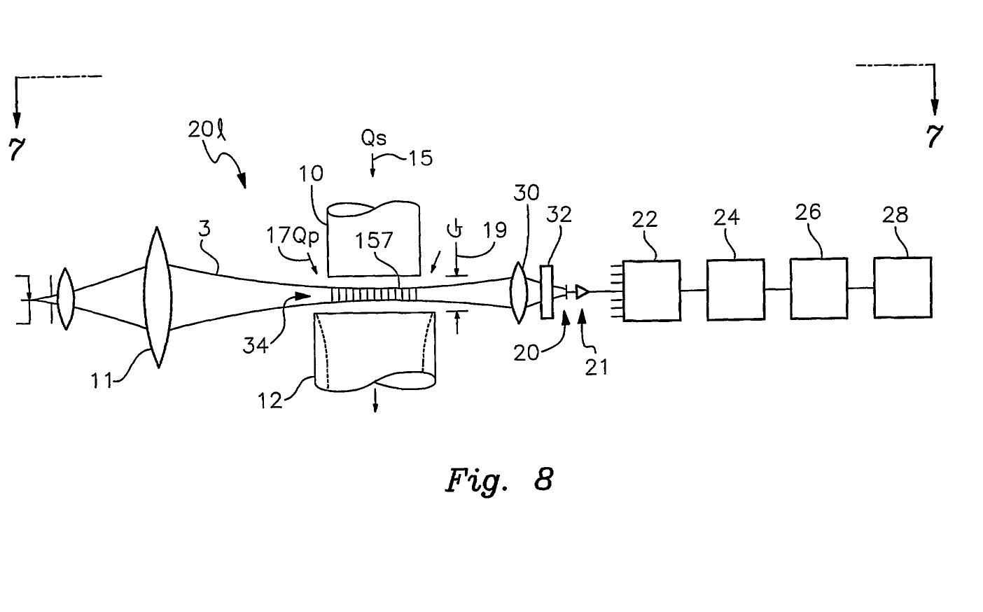

The method by which the data from these combined light scattering sensors are used to provide improved mass concentration and mass delivery measurements is described next below, where the combination is a small light scattering sensor with an extinction mode sensor, as the methods are fundamentally the same.

Whereas FIGS. 5 and 6 disclose combination of large and small scattering volumes 156 and 162 for the improved measurement of mass concentrations and size distributions for mass delivery applications, FIGS. 7 and 8 show top and front views of a combined extinction and scattering apparatus 201. It may be appreciated that the large scattering volume 156 of FIGS. 5 and 6 is replaced with the typically larger and more uniformly responsive volume 157 associated with the extinction mode sensor design of FIGS. 7 and 8. Mass concentration C may be reported in μg/liter and mass fraction (MF) in % mass associated with particles larger than size given by an effective or optical equivalent diameter in μm. Aerosols 8, whose delivery rates through transport cross section 34, in μg/second, are controlled based on the C and MF readings of apparatus 201, are transported by sample gas flow Qₛ 15, and are confined to inlet conduit 10 and outlet conduit 12 by the conduits 10 and 12 and by sheath/purge gas flow Qₚ 17.

Representative design parameters for the major elements in FIGS. 7 and 8 are:

inlet and outlet conduit diameters ˜8 mm

gap G 19˜2 mm

N₂ gas at about STP

sample transport flow Qs˜1 liter/min=16.7 ml/sec

purge flow Qp˜0.05 liter/min.

The inlet and outlet conduits 10,12 and the rest of system 201 are within a sealed vessel.

Aerosol mass delivery control apparatus as disclosed in WO 00/58016 introduces aerosols 8 into transport flow Qₛ. Downstream deposition and other apparatus collects, measures and disposes of uncollected aerosols and are therein described. The electro-optical apparatus and methods described herein represent further improvements.

The arrangement of multiple extinction and two near 90° scattering channels seen in FIGS. 7, 8 and 9, and the combination of their signals, provide three fundamental improvements which overcome limitations of prior art aerosol mass concentration and sizing instruments:

1. Spatially-resolved, full cross sectional coverage of the flow;

2. Correction for size distribution changes; and

3. Provision for “peaking” or unique response functions, r(v;d).

In FIGS. 7 and 8, multiple light detectors and amplifiers 20, 21 or equivalent charge coupled devices, following cylindrical lens 30 and neutral density filter 32, enable monitoring the uniformity of the aerosol mass concentration C across the cross section 34 via the multiple extinction mode signal responses Vₑₓₜ 23. Multiple, time and space-resolving signals Vₑₓₜ 23 from detectors/amplifiers 20,21 are received by high speed multiplexing switch 22, then analog to digital converter 24, then by microcontroller 26, and finally by system PC 28 or other general process control output device. Whereas cross sectional uniformity is important for best management and operation of mass delivery system 201, the primary data product is average or mean extinction mode signal Vₑₘ. When the intrinsic aerosol properties are constant, Vₑₘ is accurately and precisely proportional to mean aerosol mass concentration Cₘ across cross section 34. This Vₑₘ data product is realized by the weighted combination, usually but not necessarily linear, of all extinction mode signals 23 and their subsequent processing.

From the description hereinabove with reference to FIG. 4 the mean extinction mode response Vₑₘ is proportional to mean mass concentration Cₘ only if the particle size distribution PSD is constant, i.e., the mass fractions (MFs) are constant. It is similarly known that Vₑₘ depends on aerosol composition and shape. We have found that variances in particle size distribution PSD or Mass Fractions MF are generally more serious than composition and shape, which can usually be more tightly controlled by the aerosol feed stock manufacturer. Importantly, when aerosol concentration measurement system 201 of FIGS. 7, 8 and 9 is used for controlling aerosol delivery rate, it is the “as-aerosolized” feed stock that must be measured in cross section 34. PSDs or MFs can notoriously be modified by the aerosol generation, transport and, especially, the deposition steps, all of which are size selective. Accordingly, we now disclose how our methods and apparatus correct for variations in PSD or MF.

For simplicity, the explanation is for those aerosols 8 having optical equivalent diameters OED>1 μm, in which case we have found that the extinction mode signals Vₑ follow a 1/d law, to first order, as seen in FIG. 4. That is, if apparatus 201 is precisely and accurately calibrated on aerosols having volume mean diameter dₘ=2 μm, it will read precisely but inaccurately, i.e., 10% low if dm increases to 2.2 μm. Thus to correct for this inherent underresponse or underweighing with increasing dₘ, one must determine contemporaneously with Vₑₘ the PSD or MF, or dₘ which is derived from either, of the aerosols in the cross section. It follows that the indicated Cₘ above is simply corrected by the ratio dₘ/d_{mc} where dₘ is the contemporaneous value and d_{mc} is the calibration value. That is:

Cₜᵣᵤₑ=C_{indicated}×dₘ/d_{mc}. (5)

These explanations and the correction methods herein disclosed may, of course, be generalized from these simple arguments.

In some applications, it is only necessary to estimate dₘ and d_{mc}. For a practical example, methods embodied in the above-described TX sensor and system, manufactured by ppm, Knoxville, Tenn. are entirely adequate for many applications. Indeed, in some cases, when the aerosol feed stock is reliably constant, a single extinction mode channel and a single TX, scatter mode channel are satisfactory and enable a robust, simple system 200, as disclosed in FIGS. 1 and 2. Such extinction mode and scatter mode channels may use a common ribbon beam 3, or the illuminations for them may be separate. In still further embodiments of the invention, the extinction mode channel 20 and the single scatter mode channels 4, 6 may be at different points in system 201.

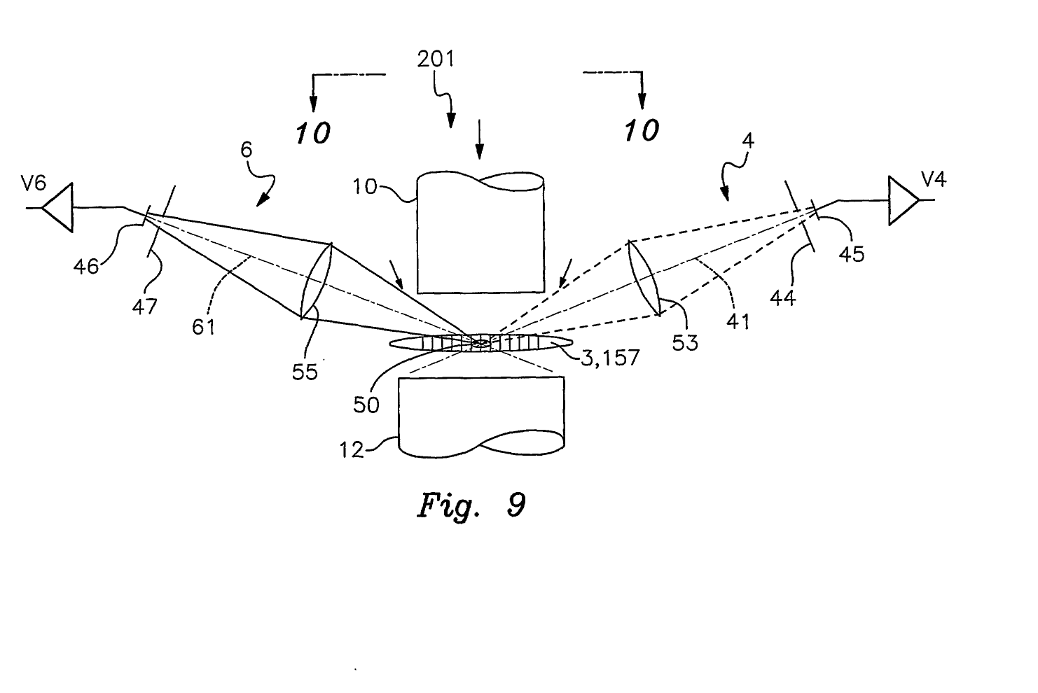

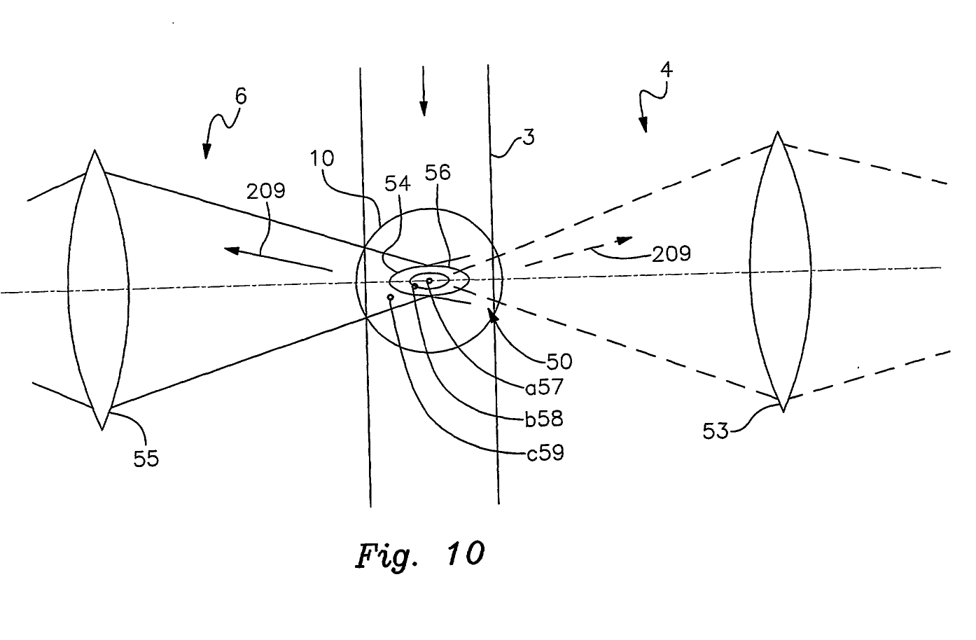

In critical applications of combined mass concentration sensors 201 to controlled mass deliveries, particularly where accuracy and precision must be maintained in the presence of variabilities in aerosol particle size distributions PSD, it is important that the electro-optical system respond very precisely and accurately to the PSD or Mass Fractions MF or volume mean diameters dₘ. This is realized to a first approximation by the dual, overlapping scattering volumes seen in overview in FIGS. 7 and 8, and in detail in FIGS. 9 and 10, and as described next below. Whereas extinction mode channels 20 in FIG. 7 cover all, or in some cases, substantially all of the transport cross section 34, the scatter mode channels cover a very small fraction of the cross section 34, typically less than about 1%.

Improved approximations to the ideal dₘ/d_{mc} corrections are realized with multiple pairs of overlapping scattering volumes. In a limit, said multiple pairs of overlapping scatter mode channels 4 and 6 are coincident with or uniquely associated with the spatially-resolved extinction mode channels 20, and this extreme combination enables an excellent approximation to perfect correction for spatial nonuniformities and PSD or MF variations when the Si calibrations and DSP methods described hereinbelow are used also.

It is first seen from FIGS. 7-10 that the scatter mode channels 4 and 6 are essentially at a 90° scattering angle with respect to the thin ribbon beam 3. They are not coplanar with the ribbon beam 3, as seen best in FIG. 9, but are typically about 10° above the ribbon 3 plane, in its thin direction. These choices of orientation of 90° and 10° are made for clarity of disclosure. Other orientations may be employed.

In FIGS. 7, 9 and 10 solid lines are used to illustrate limiting rays for the larger sampling or “view” volume Vₛ 56 associated with scattering channel 6. Dashed lines illustrate limiting rays for the smaller volume Vₛ 54 associated with scattering channel 4. Aperture 44 preceding detector 45 in the smaller Vₛ 54 channel is smaller than the aperture 47 preceding detector 46 in the larger Vₛ 56 channel 6. These apertures define larger and smaller scattering volumes within the ribbon beam 3. (It is assumed for simplicity that the thin dimension of the ribbon beam is much larger than the essentially vertical dimensions of the scattering volumes Vₛ. This, too, can be relaxed with a more general design. Indeed, very thin “ribbon beams,” wherein the beam waist 206 is smaller than the collection optics waist 216, as in FIGS. 1 and 2, are advantageous by enabling very small sampling volumes Vₛ. However, nothing is lost by the assumption in explaining the principles employed in embodiments of the invention.)

FIG. 10 is an enlargement emphasizing the overlapping scattering volumes Vₛ 50 seen first in the top view of FIG. 7, and seen also in FIGS. 9 and 10. (A general call-out, 50, with an arrow is used in these figures because of scale. FIG. 10 clarifies this use.) Both scattering channels collect light from a region of space that we call the joint response ellipsoid. That is, for each scattering channel, near 90° scattering is realized for those aerosol particles which are jointly in incident beam 3, such that radiation can fall on them, and within the principal response region or collection volumes of each of the collection optics 4 and 6. Since the scattering volume “vertical” dimensions are smaller than the thin dimension of the ribbon beam, which is assumed for simplicity, it follows that the incident intensity falling on the aerosols within each of the scattering volumes is roughly constant.

A “peaking” or unique response function r(v;d) may be realized, when the smaller scattering volume 54 lies within the larger volume 56. FIG. 10 is a top planar view of the 1/e boundaries for the two joint response ellipsoid volumes. FIGS. 11, 12 and 13 show detector response waveforms for a test particle of diameter d moving vertically along trajectories through points a, b and c in the plane of FIG. 10. We can also refer to the trajectories as a, b and c. This planar view implies the general three-dimensional character of these ellipsoid volumes, the smaller one 54 dashed and the larger one 56 solid. The logic according to which unique response is realized is as follows: A single particle of size d produces significant detector response in the small Vs channel 4 only while it is within its ellipsoid volume 54. If it produces a response V4 it follows that it must produce a response V6 from the larger scattering volume 56. But when this particle moves on a trajectory b which is near a boundary of the small channel ellipsoid volume 54, the detector response for the large channel is only slightly reduced. Thus only particles which are within the small ellipsoid volume 54 are accepted for sizing by the larger ellipsoid volume 56. That is, when the single particle voltage responses V4 and V6 are compared, only those particle for which V4/V6>fixed ratio, such as 1/e, and coincident in time, are accepted for sizing by the larger channel 6. It follows further that the combined system response is more nearly unique, or the distribution of responses to monodisperse aerosol challenge yields a so-called “peaking” response.

This logical exclusion via comparison of overlapping scattering channels causes the response to each particle to be as nearly unique as required, thus circumventing the fundamental non-peaking response when one such scattering channel is used. (That is, in the case of a single volume scatter channel, the single detector response from single particles is non-peaking: one cannot say whether a given response is due to a small particle in the center or the ellipsoid or a large one at a boundary. Or, alternatively stated: the response to monodisperse aerosols, particles of a given size, is a range of values, not a single, unique value.)

Typical dimensions for the ribbon beam 3 are 0.1 mm thickness by 10 mm width; for the smaller ellipsoid volume 54, 0.1 mm length by 0.05 mm diameter; and for the larger ellipsoid volume 56, 0.2 mm length by 0.1 mm diameter. The ellipsoid lengths and diameters are uniquely related to the aperture sizes 44,46 and magnifications of the lenses 53,55.

FIGS. 11, 12 and 13 show the detector response waveforms as a function of time for. particles moving through the overlapping or generally concentric volumes 54, 56 on three different vertical trajectories. FIG. 11 shows the detector responses to particles on trajectory a 57, near the center of the small ellipsoid volume 54. FIG. 12 shows the detector responses to particles on trajectory b 58, at a 1/e boundary point of the small ellipsoid volume 54. FIG. 13 shows the detector responses to particles on trajectory c 59, outside the large ellipsoid volume 56. Acceptable ratios V4/V6=1/e are but one choice.

Signals V4 and V6 have small particle coincidence, that is, there are a plurality of relatively smaller particles within each of the large and small sampling volumes. Such plurality or multiple particle responses occur which occurs when the aerosol concentration is high. Background levels 63 are higher for the large scattering channel 6 than the background levels 65 for the smaller volume channel 4. Note that the sensitivity in both channels 4,6 is set to produce the same signal for trajectory a 57 for the sake of simplicity in explanation but without loss of generality. Note further that the same particle of diameter d produces incremental voltage pulse A, with the peak amplitude occurring at the same instant in time in both the large 56 and small 54 volumes, for trajectory a 57. Background suppression methods are well known to deal with such coincidence, as are procedures for setting the small and large scattering volumes, 54,56, in view of the design center concentrations C and aerosol volume mean diameter d.

In view of coincidence, not of the plurality of relatively small particles but for the relatively large ones, such as one having diameter d in the above example, it follows that there is a minimum d for which single particles can be distinguished with respect to the noise in the background signal. It follows further that this restriction is set by the larger volume, not the smaller, where coincidence effects and the S/N ratio are inherently superior, as seen in FIG. 11.

In other embodiments of the invention, the number of multiple overlapping, generally coincident sampling volumes for providing peaking responses may be extended well beyond two.

The scatter mode responses V4 or V6 are actually quite complex in character, including regions of non-monotonic responses, sometime referred to as the “Mie Oscillations.” Of more practical importance, there are sometimes ranges of particle sizes d for which the underweighing does not follow 1/d. Especially near the region of the maximum response of either V_{sca} or Vₑₓₜ per unit mass, shown as unity in FIG. 4, and which maximum response occurs for those particles whose OED is about equal to the wavelength of illumination, the large particle compensation does not follow a simple V6^{3/2} form. When more complex large particle corrections are required, then the best approach is to use the unique response function apparatus described above and execute rigorous calibrations with nearly monodisperse aerosols having diameter di and of the same compositions as the aerosols to be delivered in production. Then the 3/2 law is replaced with a more rigorous Si compensation, where the Si functions or factors are developed from the monodisperse calibrations. In addition to the rigors of overlapping volumes, to produce unique responses, and size-specific calibrations of Si, the detailed nature of the V4 or V6 responses are advantageously realized with digital signal process, next described.

The V4 and V6 signals in embodiments of our invention represent the passage of a particle of size d having various trajectories through the overlapping scattering volumes. In view of the unique responses enabled thereby, it follows that PSD is related to the large channel 6 peak voltage response V6, for those particles for which V4/V6 exceeds a preset ratio and occurs at the same time. This peak voltage is determined by known peak sample and hold or by employing digital signal processing (DSP). Use of high speed (100 kHz to 1 MHz sample rates), high resolution (12 to 16 bit) digital signal processing is particularly advantageous in embodiments of the invention because not only the peak amplitude is required but their ratio of the small 4 and large 6 channels. Still further, DSP enables application of powerful background suppression or digital filtering methods, as well as fuller characterization of the waveform structural details, such as temporal coincidence, both of which enhance the ranges of applicability of embodiments of the invention.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

1. A method for measuring mass concentration of aerosols being transported in a gas flow stream, comprising:
employing a first sensor responsive to particles within a relatively larger sampling volume within the gas flow stream to develop an uncompensated output signal representative of mass concentration but uncompensated for particle size distribution, the relatively larger sampling volume having the capacity to contain a plurality of particles;
employing a second sensor responsive to particles within a relatively smaller sampling volume within the gas flow stream to develop a compensating signal representative of particle size distribution, the relatively smaller sampling volume being sized so as to contain only one particle larger than a predetermined minimum size; and
determining mass concentration by applying the compensating signal to compensate the uncompensated output signal for particle size distribution.

2. The method of claim 1, wherein the step of determining mass concentration comprises multiplying indicated mass concentration based on the uncompensated output signal by the ratio of the aerosol volume mean diameter as indicated by the compensating signal to the aerosol volume mean diameter for which the first sensor is calibrated.

3. The method of claim 1, which comprises employing an electro-optical sensor as the first sensor.

4. The method of claim 3, which comprises employing an extinction mode electro-optical sensor as the first sensor.

5. The method of claim 3, which comprises employing a scattering mode electro-optical sensor as the first sensor.

6. The method of claim 3, which comprises employing an electro-optical sensor as the second sensor.

7. The method of claim 6, which comprises employing a scattering mode electro-optical sensor as the second sensor.

8. The method of claim 1, which comprises employing an electro-optical sensor as the second sensor.

9. The method of claim 8, which comprises employing a scattering mode electro-optical sensor as the second sensor.

10. The method of claim 1, wherein the relatively smaller sampling volume is within the relatively larger sampling volume.

11. The method of claim 1, which comprises employing as the first sensor a plurality of individual sensor elements arranged so as to provide spatial resolution across the gas flow stream.

12. The method of claim 1, which comprises employing as the second sensor a plurality of individual sensor elements arranged so as to provide spatial resolution across the gas flow stream.

13. The method of claim 1, which comprises employing as the second sensor a pair of mass concentration sensor channels responsive to particles within a corresponding pair of sampling volumes, one of which is within the other.

14. A method for measuring mass concentration and particle size distribution of aerosols transported in a conduit based on light scattering from multiple sampling volumes comprising:
transporting aerosols to a measurement position in the conduit;
employing illumination, optical collectors and detectors to define a plurality of sampling volumes at the measurement position, such that the scattered light response for each of the sampling volumes is maximal inside and outside without the particular volume, and with the largest sampling volume being generally concentric with and enclosing the smallest sampling volume, and with the smallest sampling volume size based on the expected range of mass concentrations and particle size distributions to be measured, the sampling volume sizing determination being to choose said smallest volume so that individual responses are produced for minimum diameter particles in the lower end of the relatively larger particle diameter range expected;
producing light scattering signal responses in proportion to collected scattered light from individual, relatively larger particles within the sampling volumes;
producing light scattering signal responses in proportion to collected scattered light from a plurality of relatively smaller particles within the sampling volumes;
analyzing the signal responses from each of the multiple and generally concentric sampling volumes and determining by ratio and time coincidence criteria whether the individual responses from the multiple scattering volumes are valid, and processing said valid individual particle signals to produce mass concentration contribution and particle size distribution measurements for those particles larger than the minimum diameter;
analyzing the signal responses from each of the multiple and generally concentric sampling volumes and determining the mass concentration contributions from the plurality of relatively smaller particles below the minimum diameter;
combining said relatively larger particle and relatively smaller particle contributions; and
computing and presenting measurement results of total mass concentrations and particle size distributions in relation to calibration results on similar aerosols.

15. A method for measuring mass delivery rate of aerosols being transported in a gas flow stream, comprising:
measuring volumetric flow rate within the gas flow stream;
measuring mass concentration by
employing a first sensor responsive to particles within a relatively larger sampling volume within the gas flow stream to develop an uncompensated output signal representative of mass concentration but uncompensated for particle size distribution, the relatively larger sampling volume having the capacity to contain a plurality of particles,
employing a second sensor responsive to particles within a relatively smaller sampling volume within the gas flow stream to develop a compensating signal representative of particle size distribution, the relatively smaller sampling volume being sized so as to contain only one particle larger than a predetermined minimum size at a time, and
determining mass concentrations by applying the compensating signal to compensate the uncompensated output signal for particle size distribution; and
multiplying the measured volumetric flow rate by the determined mass concentration to determine mass delivery rate.

16. A method for measuring mass delivery rate of aerosols being transported in a gas flow stream, comprising:
measuring volumetric flow rate within the gas flow stream;
measuring mass concentration by employing a sensor responsive to a plurality of small particles and to individual, relatively larger particles within a sampling volume within the gas flow stream to develop compensated signals representative of particle size distribution and total aerosol concentration, and
multiplying the measured volumetric flow rate by the determined mass concentration to determine mass delivery rate.

17. A system for measuring mass concentration of aerosols being transported in a gas flow stream, comprising:
a first sensor responsive to particles within a relatively larger sampling volume within the gas flow stream to develop an uncompensated output signal representative of mass concentration but uncompensated for particle size distribution, the relatively larger sampling volume having the capacity to contain a plurality of particles;
a second sensor responsive to particles within a relatively smaller sampling volume within the gas flow stream to develop a compensating signal representative of particle size distribution, the relatively smaller sampling volume being sized so as to contain only one particle larger than a predetermined minimum size; and
an analysis device operable to determine mass concentration by applying the compensating signal to compensate the uncompensated output signal for particle size distribution.

18. The system of claim 17, wherein said analysis device determines mass concentration by multiplying indicated mass concentration based on the uncompensated output signal by the ratio of the aerosol volume mean diameter as indicated by the compensating signal to the aerosol volume mean diameter for which the first sensor is calibrated.

19. The system of claim 17, wherein said first sensor comprises an electro-optical sensor.

20. The system of claim 19, wherein said first sensor comprises an extinction mode electro-optical sensor.

21. The system of claim 19, wherein said first sensor comprises a scattering mode electro-optical sensor.

22. The system of claim 19, wherein said second sensor comprises an electro-optical sensor.

23. The system of claim 22, wherein said second sensor comprises a scattering mode electro-optical sensor.

24. The system of claim 17, wherein said second sensor comprises an electro-optical sensor.

25. The system of claim 24, wherein said second sensor comprises a scattering mode electro-optical sensor.

26. The system of claim 17, wherein the relatively smaller sampling volume is within the relatively larger sampling volume.

27. The system of claim 17, which wherein said first sensor comprises a plurality of individual sensor elements arranged so as to provide spatial resolution across the gas flow stream.

28. The system of claim 17, which wherein said second sensor comprises a plurality of individual sensor elements arranged so as to provide spatial resolution across the gas flow stream.

29. The system of claim 17, wherein said second sensor comprises a pair of mass concentration sensor channels responsive to particles within a corresponding pair of sampling volumes, one of which is within the other.

30. A system for measuring mass concentration and particle size distribution of transported aerosols based on light scattering from multiple sampling volumes comprising:
a conduit within which aerosols are transported to a measurement position;
illumination, optical collectors and detectors defining a plurality of sampling volumes at the measurement position, such that the scattered light response for each of the sampling volumes is maximal inside and minimal outside the particular sampling volume, and with the largest sampling volume being generally concentric with and enclosing the smallest sampling volume, and with the smallest sampling volume size based on the expected range of mass concentrations and particle size distributions to be measured, the sampling volume sizing determination being to choose the smallest volume so that individual responses are produced for minimum diameter particles in the lower end of the relatively larger particle diameter range expected;
said detectors producing light scattering signal responses in proportion to collected scattered light from individual, relatively larger particles within the sampling volumes;
said detectors producing light scattering signal responses in proportion to collected scattered light from a plurality of relatively smaller particles within the sampling volumes; and
an analysis system operable to
analyze the signal responses from each of the multiple and generally concentric sampling volumes and determining by ratio and time coincidence criteria whether the individual responses from the multiple scattering volumes are valid, and process the valid individual particle signals to produce mass concentration contribution and particle size distribution measurements for those particles larger than the minimum diameter,
analyze the signal responses from each of the multiple and generally concentric sampling volumes and determine the mass concentration contributions from the plurality of relatively smaller particles below the minimum diameter,
combine the relatively larger particle and relatively smaller particle contributions, and
compute and present measurement results of total mass concentrations and particle size distributions in relation to calibration results on similar aerosols.

31. A system for measuring mass delivery rate of aerosols being transported in a gas flow stream, comprising:
a flow rate sensor for measuring volumetric flow rate within the gas flow stream;
a mass concentration measurement system including
a first sensor responsive to particles within a relatively larger sampling volume within the gas flow stream to develop an uncompensated output signal representative of mass concentration but uncompensated for particle size distribution, the relatively larger sampling volume having the capacity to contain a plurality of particles,
a second sensor responsive to particles within a relatively smaller sampling volume within the gas flow stream to develop a compensating signal representative of particle size distribution, the relatively smaller sampling volume being sized so as to contain only one particle larger than a predetermined minimum size at a time, and
an analysis device operable to determine mass concentration by applying the compensating signal to compensate the uncompensated output signal for particle size distribution; and
a device for multiplying the measured volumetric flow rate by the determined mass concentration to determine mass delivery rate.

32. A system for measuring mass delivery rate of aerosols being transported in a gas flow stream, comprising:
a flow rate sensor for measuring volumetric flow rate within the gas flow stream;
a mass concentration measurement system including a mass concentration sensor responsive to a plurality of small particles and to individual, relatively larger particles within a sampling volume within the gas flow stream to develop compensated signals representative of particle size distribution and total aerosol concentration, and
a device for multiplying the measured volumetric flow rate by the determined mass concentration to determine mass delivery rate.
